(19) United States
(12) Patent Application Publication
(10) Pub. No.: US 2018/0339568 A1
(43) Pub. Date: Nov. 29, 2018

(54) SYSTEM FOR SAFELY KNEELING A VEHICLE

(71) Applicant: Dallas Smith Corp., Greencastle, IN (US)

(72) Inventors: Darren Back, Greencastle, IN (US); Judson Smith, Greencastle, IN (US)

(73) Assignee: Dallas Smith Corp., Greencastle, IN (US)

(21) Appl. No.: 15/984,802

(22) Filed: May 21, 2018

Related U.S. Application Data
(60) Provisional application No. 62/509,883, filed on May 23, 2017.

(51) Int. Cl. B60G 17/017; B60Q 9/00

(52) U.S. Cl. CPC B60G 17/017; B60Q 9/00; B60G 2300/02; B60G 2400/302; B60G 2400/30; B60G 2800/203; B60G 2500/30; B60G 2500/324; B60G 2600/044; B60G 2204/47; B60G 2800/202; B60G 2400/252

(57) ABSTRACT

Disclosed are a system and method for operating a vehicle kneeling system. A controller operates an actuator that compresses the vehicle suspension to lower the frame of the vehicle to a kneeled position. The controller verified that the transmission is set to park, and that a kneel switch is depressed, to operate the actuator. The controller continues to monitor these parameters, and when the controller detects loss of a signal, it deactivates the actuator which allows the suspension to return the vehicle to a ride height.

### CROSS-REFERENCE TO RELATED APPLICATIONS

This application claims the benefit of U.S. Provisional Application No. 62/509,883, filed May 23, 2017, which is hereby incorporated by reference.

### BACKGROUND

This disclosure is in the field of controlling vehicle kneeling.

In the last several years there has been substantial growth in the rental moving truck business, i.e., UHaul®, Penske®, Ryder® and others. This increased interest has led to improvements in the operation of rental moving trucks, which provide for a more user-friendly and safer operating vehicle. For example one of these improvements has been systems for changing the height of a vehicle such as the Squat® “kneeling” system, which hydraulically lowers the rear deck of the moving truck, allowing users an easier and safer means of loading and unloading their cargo, e.g., furniture or other heavy objects.

With the innovation in kneeling systems comes the opportunity for damage to the vehicle or injury to individuals if the kneeling system is activated at the wrong time. For example, kneeling systems are not generally designed to operate while the vehicle is moving. Moving the vehicle while it is lowered can result in damage to the vehicle, or injury to people who are close by and are not expecting the vehicle to move. The opportunity for damage or injury is also increased by the fact that the driver may be inexperienced with trucks in general, and kneeling systems in particular. This is especially an issue when the vehicle is a rental truck operated by a person who rarely operates trucks, and may have never operated a truck with a kneeling system.

Whether it is a transit shuttle bus with a deployable powered ramp, a utility truck that has a powered lift gate, or a rental moving truck with a “kneeling” system, it is imperative that the vehicle be operated safely, particularly when the kneeling system is active.

### SUMMARY

Disclosed is a system for ensuring the safe operation of a “kneeling” system used in conjunction with a vehicle, e.g. a bus, a van, or a large rental truck such as a 26′ U-Haul truck. The system includes a controller with logic that allows the “kneeling” system to safely operate when one or more parameters are met, and includes an interface system that communicates with the vehicle such as by way of an existing vehicle data bus. The System further employs redundancy to additionally ensure the safe operation of the “kneeling” system.

In general, if the vehicle's ignition is on, then the vehicle shift lever must be in “park” for the kneeling to operate. If the vehicle is in a kneeled state with the ignition on and the shift lever is removed from Park, the vehicle will immediately rise to its nominal ride height position. A processor interpreting output from the vehicle controller accomplishes this for example by interrogating a PTO Park signal.

A master power switch may be included as an emergency override for safety. At any time the master switch is turned off, whether during kneeling or when the vehicle is already lowered, the vehicle immediately rises to its nominal ride height position. The processor is thus programmed to respond to input from the master power switch as an emergency override or default.

Besides the master power switch, a user activated kneeling button is included to activate the system. Safety features related to the use of this button are included as well. In one example, the kneeling button must be pushed and held for five seconds before the vehicle will kneel. After holding the kneeling button for an initial wait period (e.g., 3 seconds), an audible alarm at the rear of the vehicle will sound, and an indicator light in the vehicle's cab will begin flashing for two seconds before the kneeling process actually begins. These features are included to warn both the operator of the vehicle, and any individual standing around the vehicle, that the vehicle is about to lower. When the kneeling process is complete, the audible alarm will turn off and the indicator light will indicate the vehicle is in a kneeled state (e.g., steady on and not flashing).

Other features that may be included in the system include that the vehicle will stay in the lowered state when the ignition is shut off, or when the engine is started, provided the master safety switch is on and all other aspects of the vehicle's operation are determined by the controller to be safe. In another aspect, the vehicle will not automatically lower when a master switch is on and the transmission is placed in park. In another aspect, the audible alarm will sound for two seconds prior to kneeling and will stay active until the unit is lowered, at which time the alarm will cease to sound. In another aspect, if the vehicle is kneeling, or kneeled, and the controller determines that it is no longer safe for the vehicle to remain in this position, the controller will automatically raise the vehicle without delay. In another aspect, the vehicle may be programmed to only allow one kneeling cycle per ignition key cycle to keep users from unnecessarily cycling the system.

### BRIEF DESCRIPTION OF THE DRAWINGS

FIG. 1 is a component diagram illustrating various aspects of the disclosed system for safely kneeling a vehicle.

FIG. 2 illustrates the system of FIG. 1 with the vehicle in the lowered (i.e. “kneeled”) position.

FIG. 3 illustrates an example schematic diagram for a pump wiring harness usable in the system of FIG. 1.

FIG. 4 is a flow diagram illustrating a safety routine executed by the controller of FIG. 1.

FIG. 5 is a flow diagram illustrating a routine for lowering a vehicle executed by the controller of FIG. 1.

FIG. 6 illustrates an example schematic diagram for a control wiring harness usable in the system of FIG. 1.

FIG. 7 illustrates an example schematic diagram for an extension harness usable in the system of FIG. 1.

FIG. 8 illustrates a safety routine executed by the controller of FIG. 1.

### DETAILED DESCRIPTION

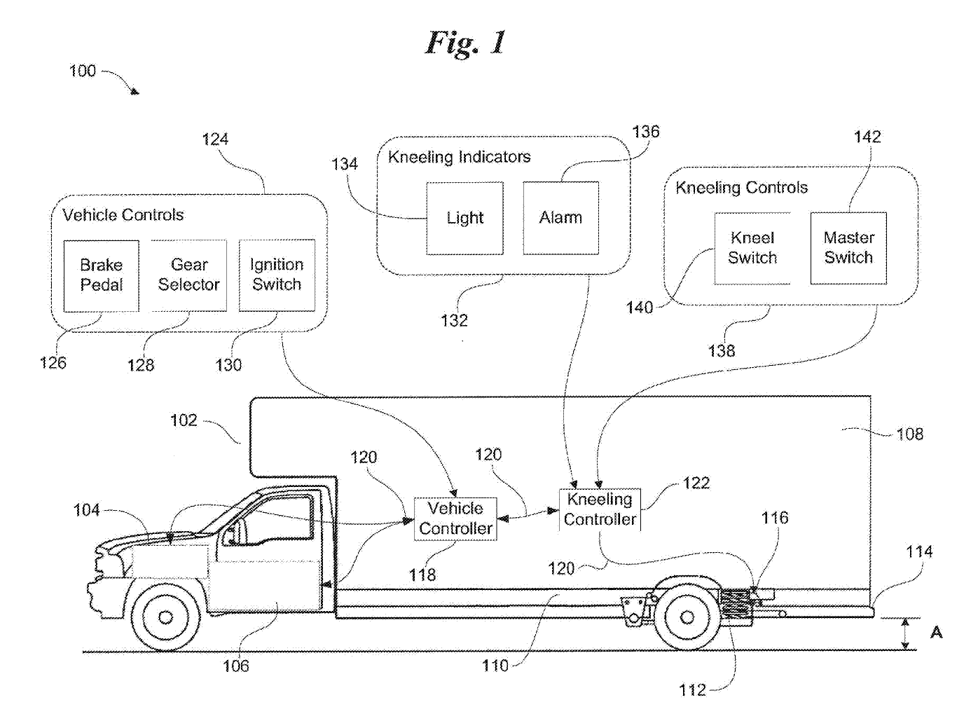

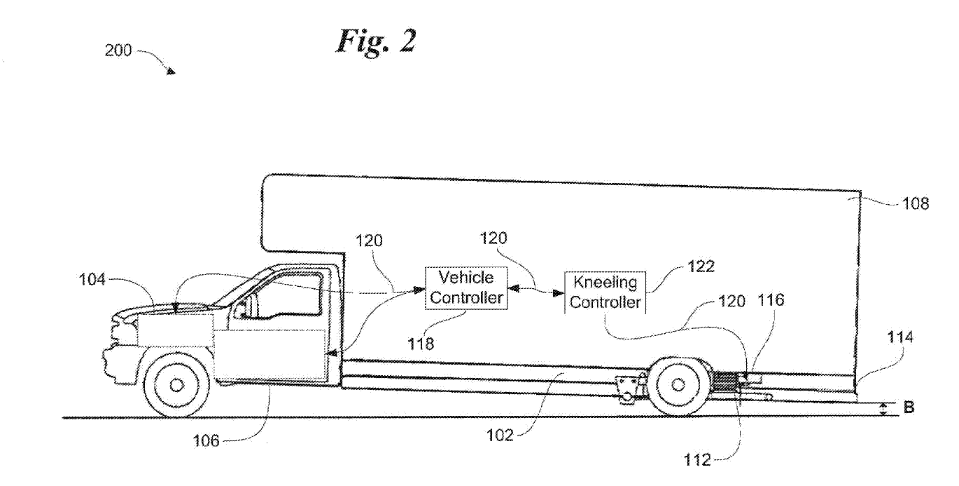

With respect to the organization and description of figures, the reference numerals in the detailed description are organized to aid the reader in quickly identifying the drawings where various components are first shown. In particular, the drawing in which an element first appears is typically indicated by the left-most digit(s) in the corresponding reference number. For example, an element identified by a “100” series reference numeral will first appear in FIG. 1, an element identified by a “200” series reference numeral will first appear in FIG. 2, and so on.

FIG. 1, illustrates at 100 one example of a controller for a “kneeling” vehicle system applied to a vehicle that is configured to “kneel” at the rear. In this example, the vehicle is a moving truck such as may be rented by a homeowner or individual seeking to move their personal belongings or other items. The concept of “kneeling” a vehicle generally involves reducing the ride height of the vehicle by lowering the cargo floor of the vehicle closer to the ground. This may be accomplished by any suitable means such as by manipulating the suspension system of the vehicle. Vehicles such as trucks, buses, vans, and others use suspension systems that can include air springs, leaf springs, coil springs, and the like. Kneeling systems may thus adjust the height of the vehicle by compressing or decompressing the vehicle suspension system thereby lowering (“kneeling”) the vehicle or raising it. This allows the operator to bring the vehicle's frame and cargo area closer to the ground, or to align it with loading docks, platforms, and the like. In FIGS. 1 and 2, the rear of the vehicle can be lowered from a first height A to a second lower height B. However, other examples are envisioned such as vehicles with systems that can adjust the height of the front of the vehicle, either side of the vehicle, the entire vehicle, and any combination thereof.

Once in the lowered position as shown in FIG. 2, it may be detrimental to the vehicle or to people standing nearby for the vehicle to be driven. This may cause damage to the vehicle, and possibly injury to others in the area. For example, in the case of a public bus that is configured to kneel to allow people to easily step on and off of the bus, people stepping onto the bus in a lowered position would likely not realize it is moving. Similarly, operating a vehicle when the suspension has been adjusted to the lowered position may cause damage to the tires, suspension, drive train, or other parts of the vehicle.

In FIGS. 1 and 2, vehicle 102 includes an engine 104 such as a gasoline or diesel engine for providing power to move the vehicle, and a transmission 106 of any suitable type configured to transfer power from the engine 104 to the rest of the drive train and ultimately to the wheels. The vehicle 102 (in this case a moving truck), includes a cargo area 108 supported by a frame 110 and a suspension system 112. A rear deck area 114 may include steps, a ramp, or other support structures which may be useful in moving goods into and out of cargo area 108.

The operation of the engine, transmission, and other aspects of the vehicle are controlled by a vehicle controller 118. Vehicle controller 118 may accept input from multiple vehicle controls 124 that may include, but are not limited to, brake pedal 126, gear selector 128, and ignition switch 130. Controller 118 may communicate with engine 104, and transmission 106, or any other devices, sensors, actuators, and the like in vehicle 102 using a communications system 120 such as a vehicle data bus. This communication system 120 includes one or more connections such as electrical wire, optical fibers, and the like. These connections are configured to carry data between the various components of the vehicle that are connected together. One example of such a communication system is a Controller Area Network bus (CAN bus). However, any suitable communication system that allows microcontrollers, sensors, and other devices throughout the vehicle to communicate with each other is envisioned.

Suspension system 112 includes a kneeling actuator 116 that is configured to adjust the height of frame 110 and cargo area 108 by compressing the suspension. An example of a kneeling actuator is disclosed in U.S. patent application Ser. No. 15/225,235 titled SUSPENSION FOR A MULTIPLE HEIGHT VEHICLE and published as US Pub. No. 2016/0339823. Actuator 116 may include a hydraulic cylinder. Actuator 116 may be controlled by a kneeling controller 122 and may be responsive to commands to raise, lower, or perform other operations related to changing the load height of the vehicle. Kneeling controller 122 uses communication system 120 to receive information about the state of the vehicle from vehicle controller 118. Such information may include its speed, current gear, whether the engine is running or stopped, tire pressure, whether the brake pedal is depressed, or any other suitable data.

Controller 122 may also accept input from the operator of the vehicle received via kneeling controls 138. These controls may include any suitable devices for accepting input from an operator such as a kneeling switch 140, and a master switch 142. Kneeling controller 122 may provide as output control instructions or data to actuator 116 and vehicle controller 118. User interface aspects of the system to provide the operator with feedback as to the state of the kneeling system may include kneeling indicators 132 such as a visible light 134 which may be an LED positioned inside the cab, or other such indicator showing the vehicle to be in a raised or lowered state. A light as a yellow strobe or other such indicator may also be positioned outside the vehicle and configured to flash or otherwise attract attention to those in the area. An audible alarm 136 may also be included and may be inside the cab (i.e. a buzzer), or outside the cab, in either case to provide warning to the operator and to those standing nearby that the vehicle is about to change height. Control logic in kneeling controller 122 is configured to accept input from the vehicle, monitor those inputs and make decisions on how to safely operate the kneeling aspect of the vehicle. This control logic may be stored in any suitable type of memory device and may be executed by a processor, microcontroller, or any other suitable digital or analog circuitry.

Adjustments to the position or configuration of suspension 112 may be performed by actuator 116 to raise or lower frame 110, cargo area 108 and rear deck area 114 from a first height A shown in FIG. 1, to a second height B shown in FIG. 2. For example, actuator 116 may be configured to increase or decrease the pressure in an air spring, actuate a hydraulic cylinder or to compress or decompress a leaf or coil spring assembly to name a few nonlimiting examples. In FIG. 2, the cargo area 108 and rear deck 114 are lowered by actuator 116 compressing a coil and/or leaf spring assembly. As shown in FIG. 2, a kneeling system can optionally be used to move only a portion of the vehicle closer to the ground. As shown in FIG. 2, actuator 116 only compresses suspension 112 in the rear of the vehicle. In other embodiments, not illustrated, one or more actuators can be used to compress suspensions on all wheels to raise and lower the entire vehicle.

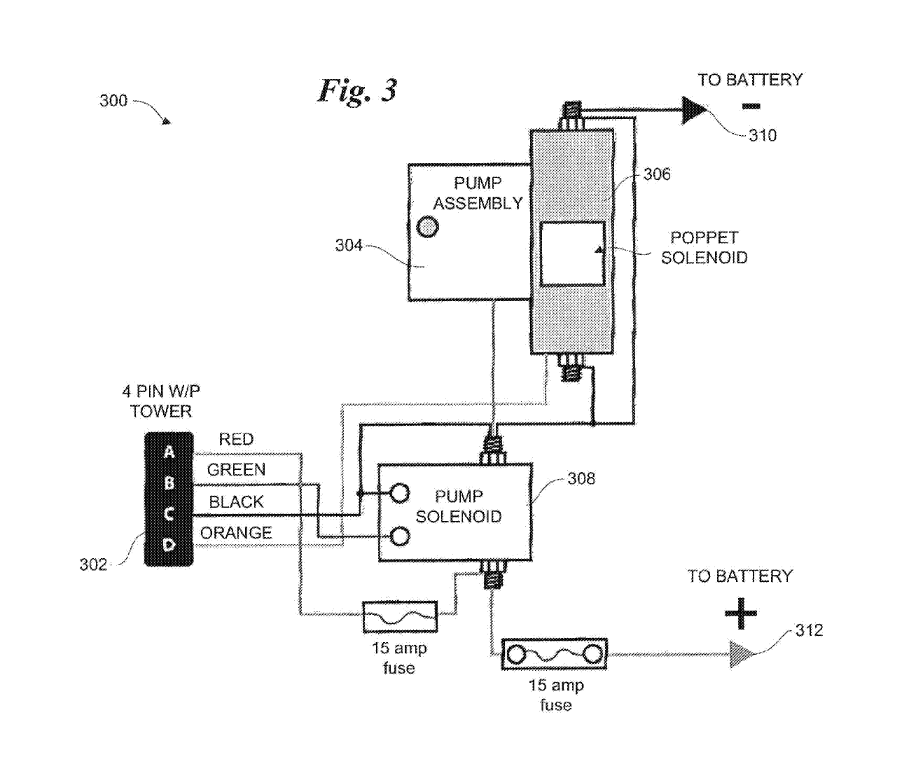

Additional implementation details of one example of an actuator 116 appear at 300 in FIG. 3. An electrical connector 302 has one or more electrical connections (e.g. A-D, each a separate wire in this case) carrying control signals from a control circuit such as kneeling controller 122. In this example, signals received from pin B control a pump solenoid 308 that is electrically connected to a pump assembly 304 and battery leads 310 and 312. Pump solenoid 308 is configured to electrically activate or deactivate pump assembly 304. Pump assembly 304 may be coupled to a hydraulic cylinder or other such actuator to change the height above the ground of cargo area 108 of vehicle 102 by compressing suspension 112. A poppet solenoid and valve assembly 306 may be included to electrically control whether the pump assembly 304 raises or lowers the vehicle based on input signals received from pin D of connector 302.

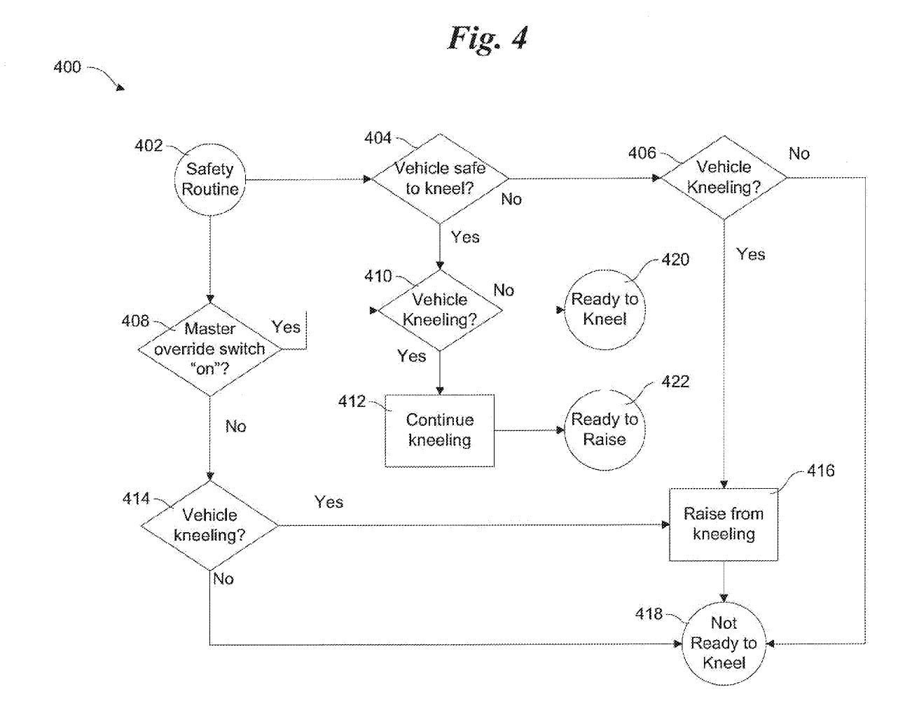

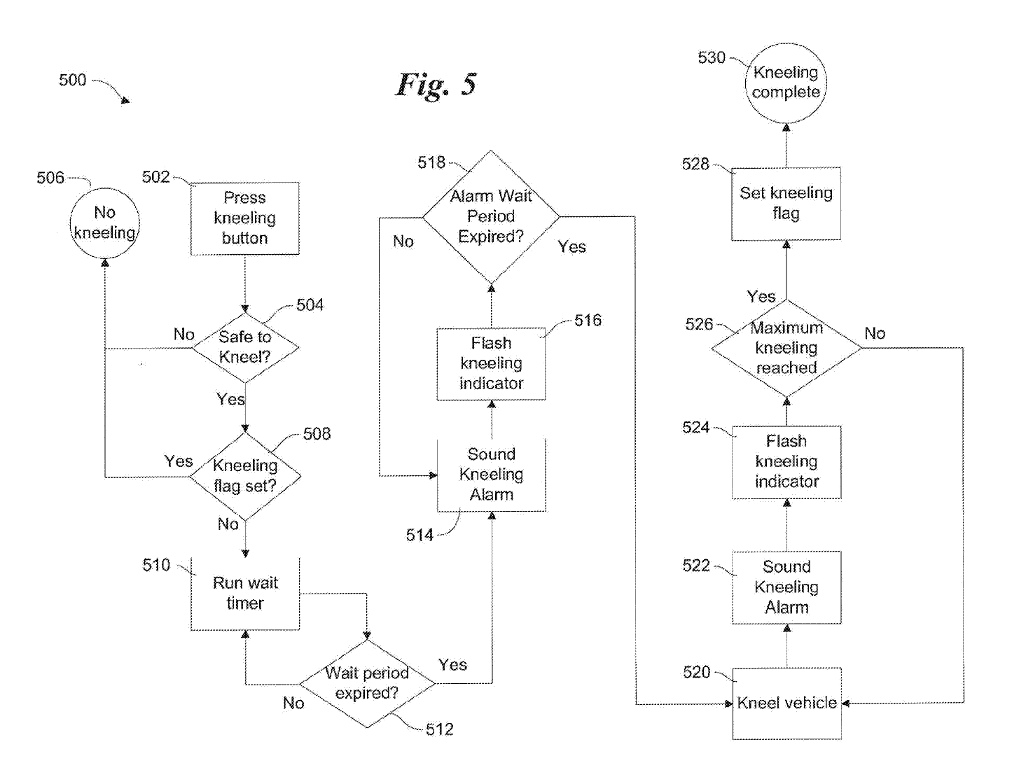

An example of some of the control logic executed by kneeling controller 122 to safely manage raising and lowering the vehicle is illustrated in FIGS. 4 and 5. One example of logic for determining at any given time when it is safe to raise or lower the vehicle appears in FIG. 4 at 400. Execution of a safety routine begins at 402 and includes multiple checks which may occur simultaneously. For example, at the same time the system may determine at 404 whether the vehicle is in a safe position to kneel while also determining whether or not the master override switch is on at 408.

Determining when the vehicle is safe to kneel includes accepting input from the vehicle itself such as by receiving input from vehicle controller 118. Such input may include any suitable aspect of the vehicle operation such as whether the gearshift is in “park.” If the vehicle is safe to kneel the controller may then determine whether the vehicle is actually kneeling at 410. This can include determining whether the vehicle is either completely or partially lowered, or in the process of lowering. In either case, the controller allows the vehicle to continue kneeling at 412, and it can continue lowering to the ground or remain in a previously set lowered position. Once lowered, the vehicle is ready to raise at 422.

Generally speaking, if the vehicle is not in a state where it is safe to lower or remain lowered, then the controller will not allow it to be lowered. For example, if the vehicle is not safe to kneel at 404, and it is currently in the process of lowering, or is already lowered, the controller automatically raises the vehicle from a lowered position at 416 leaving the system in a state where the vehicle is not ready to kneel at 418.

The master override switch acts as a way for the operator of the vehicle to immediately disable the kneeling system and bring the vehicle back into a raised position. For example, if the master override switch is off at 408, and the vehicle is lowering or is already lowered at 414, then the controller will automatically raise the vehicle from a kneeling position at 416, leaving it in a state where it is not ready to kneel at 418. The system will not be ready to kneel again until the master override switch is reactivated.

When the master override switch is on at 408, the system also determines if the vehicle is kneeling at 410 and allows it to continue kneeling at 412 leaving it in a position where it is ready to raise at 422. If the vehicle is not kneeling at 410, then the system is left in a ready to kneel state at 420.

In general, the safety of the vehicle takes precedence over the operation of the master override switch. If the vehicle should become unsafe to operate in a lowered position, then it is raised regardless of whether the master override switch is on or off. The master override switch provides a way to activate the system and prepare it for the kneeling and to deactivate the system causing it to immediately rise. In this example, activating the master override switch does not automatically cause the vehicle to lower but allows the operator a way to immediately cause the vehicle to raise into a travel position without putting the vehicle in an unsafe condition.

One example of control logic implemented by controller 122 for lowering the vehicle appears at 500 in FIG. 5. The controller accepts input from the operator such as by pressing the kneeling button at 502. If the vehicle is not safe to kneel at 504, no change in position of the cargo area takes place in the routine halts at 506. If the vehicle is safe to lower at 504, the controller may check to determine if a flag has been set at 508. Such a flag may be used to avoid cycling the system too many times within a fixed period of time. For example, the flag may be set when the vehicle is lowered and reset when the operator starts or stops the engine with the key switch.

If the kneeling flag has not been set at 508, a wait timer may be started at 510 thus requiring the user to press and hold the kneeling button until a wait period has expired at 512. This wait period may be any suitable continuous period of time such as less than three seconds or less than five seconds or less than any other suitable continuous time greater than or equal to five seconds. When the wait period is expired at 512, an audible kneeling alarm may be sounded at 514 to warn the operator and others in the area of the vehicle that the vehicle is about to lower. A kneeling indicator at 516 may also flash until an alarm wait period is expired at 518. This alarm wait period may be any suitable length of time such as less than two seconds less than five seconds, or some other suitable period of time greater than or equal to five seconds. If the operator continues to press and hold the kneeling button, and the wait period and alarm period have expired, the vehicle will kneel at 520. The kneeling alarm at 522 and flashing indicators at 524 (or other warning indicators) continue until the operator releases the kneeling button, or the maximum kneeling height is reached at 526. The kneeling flag may then be set at 528 and kneeling is complete at 530. As discussed previously with respect to FIG. 4, the safety logic is executed at all times during the kneeling operation described in FIG. 5 so that if the vehicle changes to an unsafe state, or the master shut off switch is deactivated during the kneeling operation, the system will automatically raise the vehicle.

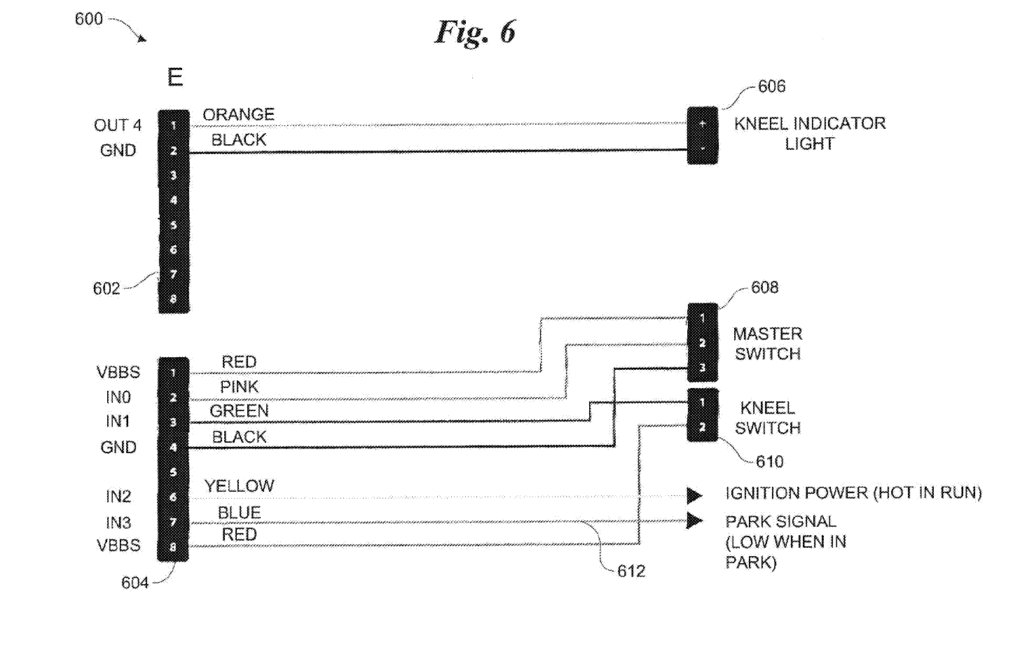

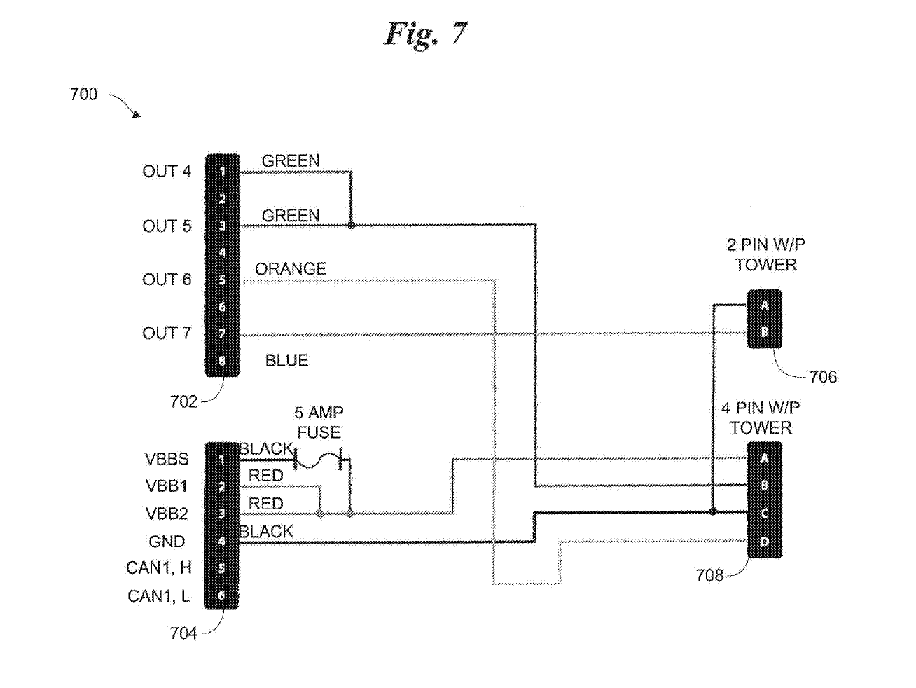

Additional implementation details of the system are included in FIGS. 6 and 7 where examples of wiring diagrams are shown illustrating at 600 and 700 how the controller may be fitted (or retrofitted) to the vehicle's communication system (or to other wiring). In FIG. 6, a connector 612 provides output to a kneeling indicator light connected to connector 606. This allows controller 122 to control the indicator light as described herein. Another connector 604 includes multiple wire connections for receiving input into controller 122 such as from a master switch connector 608 connected to the master switch, and a kneeling switch connector 610 connected to the kneeling switch. An input connection 612 may provide input into controller 122 indicating when the vehicle is in park. As discussed above, the signal, and possibly others, may be used to determine when the vehicle is safe to lower. Similarly, connectors 702 and 704 are shown at 700 in FIG. 7 and are connected to corresponding connectors 706 and 708. Connector 708 may be electrically connected to a pump assembly like the one illustrated in FIG. 3. For example, connector 708 may be coupled to connector 302 thus allowing the kneeling controller to raise or lower the vehicle by operation of the pump assembly.

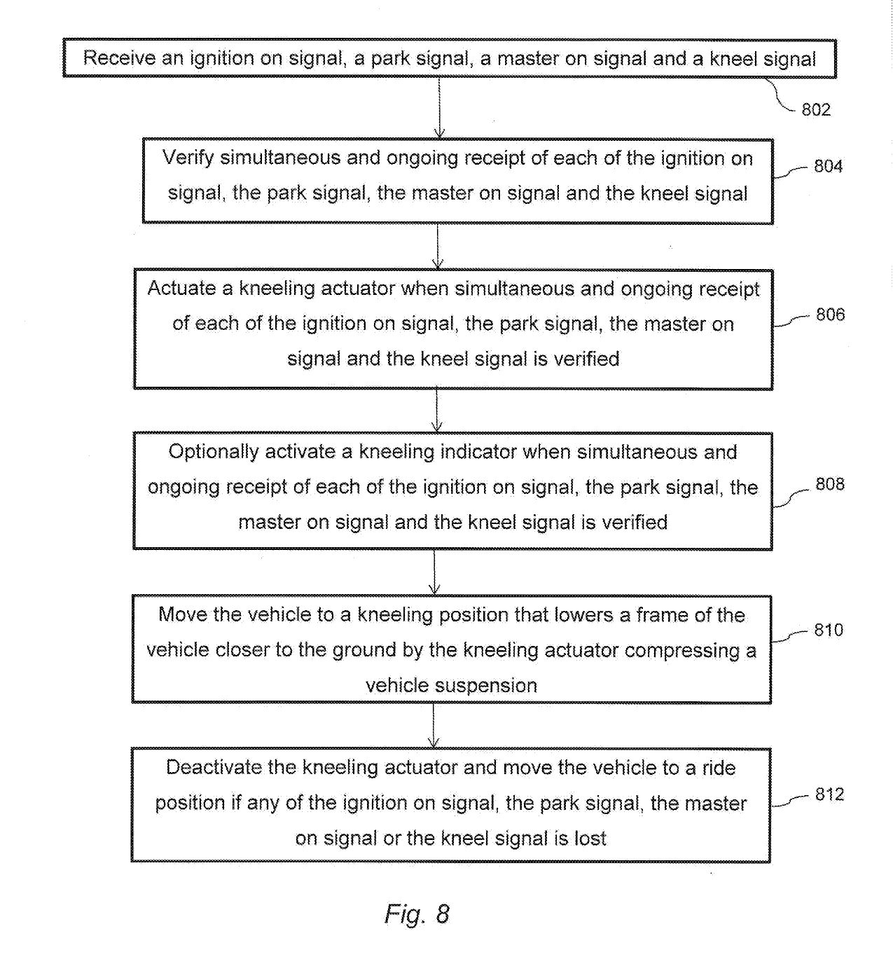

A high level summary of the control logic of kneeling controller 122 is shown in FIG. 8 which illustrates procedure 800. Procedure 800 being with step 802 wherein kneeling controller 122 receives an ignition on signal and a park signal from vehicle controls 124, a master on signal from master switch 142 and a kneel signal from kneel switch 140. In step 804, kneeling controller 122 verified simultaneous and ongoing receipt of each of the ignition on signal, the park signal, the master on signal and the kneel signal. In step 806, kneeling controller 122 actuates kneeling actuator 116 when simultaneous and ongoing receipt of each of the ignition on signal, the park signal, the master on signal and the kneel signal is verified. In step 808, kneeling controller 122 optionally activates light 134 and/or alarm 136 when simultaneous and ongoing receipt of each of the ignition on signal, the park signal, the master on signal and the kneel signal is verified.

Step 806 leads to step 810 where kneeling actuator 116 compresses suspension 112 and moves frame 110 to a kneeled position with frame 110 closer to the ground. In step 812, kneeling controller 122 deactivates kneeling actuator 116, which permits frame 110 to move back to a ride position, when kneeling controller 122 detects loss of any of the ignition on signal, the park signal, the master on signal or the kneel signal.

In one aspect, a vehicular system is disclosed that includes an ignition switch having an “on” position, a gear selector coupled to a transmission having a “park” position, a vehicle controller that outputs an ignition on signal when the ignition switch is in the “on” position and a park signal when the transmission is set to the “park” position, a frame that has a ride height and a kneeled height that is closer to the ground than the ride height, a suspension system that defines a ride condition where the frame is at the ride height and a kneeled condition where the frame is at the kneeled height, where the suspension system is biased toward the ride height, a kneeling actuator that compress the suspension system against the bias of the suspension system to move the suspension system from the ride condition to the kneeled condition, a master switch that outputs a master on signal when the master switch is set to an “on” position, a kneel button that outputs a kneel signal when the kneel button is actuated; and a kneeling controller that monitors each of the ignition on signal, the park signal, the master on signal and the kneel signal and also actuates the kneeling actuator to move the suspension system from the ride condition to the kneeled condition when the kneeling controller detects simultaneous and ongoing receipt of each of the ignition on signal, the park signal, the master on signal and the kneel signal.

In a further aspect, the kneeling controller may optionally delay actuating the kneeling actuator until receipt of a continuous kneel signal that is more than 3 seconds long.

In another aspect, the kneeling controller can deactivate the kneeling actuator to move the suspension system from the kneeled condition to the ride condition due to the bias of the suspension system when any one of the park signal, the ignition on signal, the master on signal, or the kneel signal is lost.

In yet another aspect, the vehicle can optionally include a kneeling indicator, where the kneeling controller activates the kneeling indicator when the kneeling controller detects simultaneous receipt of each of the ignition on signal, the park signal, the master on signal and the kneel signal. The kneeling indicator can be, for example, a light, an alarm or both a light and an alarm.

In another related aspect, the kneeling actuator can be a hydraulic cylinder with the kneeling controller actuating a pump assembly to actuate the hydraulic cylinder.

In each of these aspects, the kneeling actuator can optionally be configured to only move a portion of the vehicle closer to the ground.

In another aspect, a method of controlling a vehicle kneeling system is disclosed. The method includes in a controller, receiving an ignition on signal indicating that an ignition key switch for the vehicle is “on”, receiving a park signal indicating that a transmission of the vehicle is set to “park”, receiving a master on signal indicating that a master switch is “on”, and receiving a kneel signal indicating actuation of a kneel button. If the controller verifies simultaneous and ongoing receipt of each of the ignition on signal, the park signal, the master on signal and the kneel signal then the controller actuates a kneeling actuator that moves the vehicle to a kneeling position that lowers a frame of the vehicle closer to the ground.

In another aspect of the method, the controller can optionally delay actuating the kneeling actuator until receipt of a continuous kneel signal of more than 3 seconds.

In yet another aspect of the method, when the controller detects loss of any of the park signal, the ignition on signal, the master on signal or the kneel signal, the controller deactivates the kneeling actuator.

In a related aspect, when the controller detects simultaneous receipt of each of the ignition on signal, the park signal, the master on signal and the kneel signal, a kneeling indicator can optionally be activated. The kneeling indicator can be, for example, a light, an alarm or both a light and an alarm.

In another related aspect, the kneeling actuator is a hydraulic cylinder and the controller actuates a pump assembly that actuates the hydraulic cylinder.

In each of these aspects, the kneeling actuator can optionally be configured to only move a portion of the vehicle closer to the ground.

It should be noted that the singular forms “a”, “an”, “the”, and the like as used in the description and/or the claims include the plural forms unless expressly discussed otherwise. For example, if the specification and/or claims refer to “a device” or “the device”, it includes one or more of such devices.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected.

What is claimed is:

1. A vehicular system comprising:
an ignition switch including an “on” position;
a gear selector coupled to a transmission and including a “park” position;
a vehicle controller that outputs an ignition on signal when the ignition switch is in the “on” position and a park signal when the transmission is set to the “park” position;
a frame having a ride height and a kneeled height that is closer to the ground than the ride height;
a suspension system having a ride condition in which the frame is at the ride height and a kneeled condition in which the frame is at the kneeled height, wherein the suspension system is biased toward the ride height;
a kneeling actuator adapted to compress the suspension system against the bias of the suspension system to move the suspension system from the ride condition to the kneeled condition;
a master switch that outputs a master on signal when the master switch is set to an “on” position;
a kneel button that outputs a kneel signal when the kneel button is actuated; and
a kneeling controller adapted to monitor each of the ignition on signal, the park signal, the master on signal and the kneel signal and further adapted to actuate the kneeling actuator to move the suspension system from the ride condition to the kneeled condition when the kneeling controller detects simultaneous and ongoing receipt of each of the ignition on signal, the park signal, the master on signal and the kneel signal.

2. The vehicular system of claim 1, wherein the kneeling controller is adapted to delay actuating the kneeling actuator until receipt of a continuous kneel signal more than 3 seconds.

3. The vehicular system of claim 2, wherein the kneeling controller is adapted to deactivate the kneeling actuator to move the suspension system from the kneeled condition to the ride condition due to the bias of the suspension system upon loss of any one of the park signal, the ignition on signal, the master on signal, or the kneel signal.

4. The vehicular system of claim 3, further comprising a kneeling indicator, wherein the kneeling controller is adapted to activate the kneeling indicator when the kneeling controller detects simultaneous receipt of each of the ignition on signal, the park signal, the master on signal and the kneel signal.

5. The vehicular system of claim 4, wherein the kneeling indicator is selected from the group consisting of a light, an alarm and both a light and an alarm.

6. The vehicular system of claim 4, wherein the kneeling actuator is a hydraulic cylinder and wherein the kneeling controller actuates a pump assembly that actuates the hydraulic cylinder.

7. The vehicular system of claim 6, wherein the kneeling actuator only moves a portion of the vehicle closer to the ground.

8. The vehicular system of claim 1, wherein the kneeling controller is adapted to deactivate the kneeling actuator to move the suspension system from the kneeled condition to the ride condition due to the bias of the suspension system upon loss of any one of the park signal, the ignition on signal, the master on signal, or the kneel signal.

9. The vehicular system of claim 1, wherein the kneeling actuator only moves a portion of the vehicle closer to the ground.

10. The vehicular system of claim 1, further comprising a kneeling indicator, wherein the kneeling controller is adapted to activate the kneeling indicator when the kneeling controller detects simultaneous receipt of each of the ignition on signal, the park signal, the master on signal and the kneel signal.

11. A method of controlling a vehicle kneeling system in a vehicle having a kneeling controller, the method comprising:
in the kneeling controller, receiving an ignition on signal indicating that an ignition key switch for the vehicle is “on”;
in the kneeling controller, receiving a park signal indicating that a transmission of the vehicle is set to “park”;
in the kneeling controller, receiving a master on signal indicating that a master switch is “on”;
in the kneeling controller, receiving a kneel signal indicating actuation of a kneel button;
in the kneeling controller, verifying simultaneous and ongoing receipt of each of the ignition on signal, the park signal, the master on signal and the kneel signal;
actuating a kneeling actuator with the kneeling controller upon verification of simultaneous and ongoing receipt of each of the ignition on signal, the park signal, the master on signal and the kneel signal; and
with the kneeling actuator, moving the vehicle to a kneeling position that lowers a frame of the vehicle closer to the ground.

12. The method of claim 11, further comprising, before activating the kneeling actuator, delaying actuating the kneeling actuator until receipt of a continuous kneel signal of more than 3 seconds.

13. The method of claim 12, further comprising deactivating the kneeling actuator upon loss on any one of the park signal, the ignition on signal, the master on signal or the kneel signal.

14. The method of claim 13, further comprising, upon verification of simultaneous receipt of each of the ignition on signal, the park signal, the master on signal and the kneel signal, activating a kneeling indicator.

15. The method of claim 14, wherein the kneeling indicator is selected from the group consisting of a light, an alarm and a light and alarm.

16. The method of claim 15, wherein the vehicle includes a vehicle controller that provides the ignition on signal and the park signal.

17. The method of claim 16, wherein the kneeling actuator is a hydraulic cylinder and wherein the kneeling controller actuates a pump assembly that actuates the hydraulic cylinder.

18. The method of claim 11, further comprising deactivating the kneeling actuator upon loss on any one of the park signal or the ignition on signal, the master on signal, the kneel signal thereby moving the vehicle out of the kneeling position.

19. The method of claim 11, further comprising, upon verification of simultaneous receipt of each of the ignition on signal, the park signal, the master on signal and the kneel signal, activating a kneeling indicator selected from the group consisting of a light, an alarm, and a light and an alarm.

20. The method of claim 11, wherein the kneeling actuator only moves a portion of the vehicle closer to the ground.
